(19) United States
(12) Patent Application Publication
(10) Pub. No.: US 2018/0172221 A1
(43) Pub. Date: Jun. 21, 2018

(54) LED LENS FOR BACKLIGHT UNIT

(71) Applicant: ANYCASTING CO., LTD., Seoul (KR)

(72) Inventors: Sungbin KIM, Goyang-si, Gyeonggi-do (KR); Byungwook KIM, Incheon (KR)

(73) Assignee: ANYCASTING CO., LTD., Seoul (KR)

(21) Appl. No.: 15/128,436

(22) PCT Filed: May 27, 2016
(86) PCT No.: PCT/KR2016/005673

§ 371 Date: Sep. 23, 2016

(30) Foreign Application Priority Data
May 27, 2015 (KR) 10-2015-0073573
Oct. 1, 2015 (KR) 10-2015-0138389

(51) Int. Cl. F21K 9/69; F21V 5/04; G09F 13/04

(52) U.S. Cl. CPC F21K 9/69; G09F 13/0409; F21V 5/045

(57) ABSTRACT

A light emitting diode (LED) lens for a backlight unit for uniformly distributing light emitted from an LED chip that emits light via a volume source. The LED lens for a backlight unit includes a lower surface including an incident surface through which light emitted from the LED chip is incident upon the LED lens, an emissive surface from which the light incident upon the LED lens is emitted, and a total-reflection surface included in the lower surface so as to total-reflect the light emitted from the LED chip and incident upon the LED lens toward the emissive surface, wherein the total-reflection surface includes a first total-reflection surface convex downward and a second total-reflection surface connected to the first total-reflection surface and convex upward, and an inflection point is formed between the first total-reflection surface and the second total-reflection surface.

### TECHNICAL FIELD

The present invention relates to a light emitting diode (LED) lens for a backlight unit, and more particularly, to an LED lens for a backlight unit, for uniformly distributing light emitted from an LED chip that emits light via a volume source.

### BACKGROUND ART

In general, a display device used as a computer monitor, a television (TV), and so on includes a liquid crystal display (LCD). The LCD itself is not capable of emitting light and, thus, requires a separate light source.

As a light source for an LCD, a plurality of fluorescent lamps such as a cold cathode fluorescent lamp (CCFL) and external electrode fluorescent lamp (EEFL) may be used or a plurality light emitting diodes (LEDs) may be used. The light source may be installed in a backlight unit (BLU) along with a light guide plate, a plurality of optical sheets, a reflecting plate, and so on.

Recently, among these light sources, LEDs have low power consumption, high durability, and low manufacturing costs and, thus, have attracted attention as a next-generation light source. However, when LEDs are used as a light source, light tends to be concentrated in a narrow region and, thus, there is a need to uniformly distribute light in a wide area in order to apply the LED to a surface light source such as a display device.

Accordingly, recently, research has been actively conducted into an LED lens for performing such a function and Korean Patent Nos. 10-0971639 and 10-0977336 are representative examples of the prior art.

However, an LED lens according to the prior art is not appropriate for an LED that emits light via a volume source in that the LED lens is designed by assuming a light source of light emitted from an LED as a point source.

### DISCLOSURE

### Technical Problem

An object of the present invention devised to solve the problem lies on a light emitting diode (LED) lens for a backlight unit, for uniformly distributing light emitted from an LED chip that emits light via a volume source.

### Technical Solution

The object of the present invention can be achieved by providing a light emitting diode (LED) lens for a backlight unit, for uniformly diffusing light emitted from an LED chip, the LED lens including a lower surface comprising an incident surface through which light emitted from the LED chip is incident upon the LED lens, an emissive surface from which the light incident upon the LED lens is emitted, and a total-reflection surface included in the lower surface so as to total-reflect the light emitted from the LED chip and incident upon the LED lens toward the emissive surface, wherein the total-reflection surface includes a first total-reflection surface convex downward and a second total-reflection surface connected to the first total-reflection surface and convex upward, and an inflection point is formed between the first total-reflection surface and the second total-reflection surface.

The inflection point may be formed at a point within a range of ⅖ to ⅗ of a radius of the LED lens from a central axis of the LED chip.

The inflection point may be formed at a point of ½ of the radius of the LED lens from the central axis of the LED chip.

The total-reflection surface may further include a third total-reflection surface that is connected to the second total-reflection surface and total-reflects light Fresnel-reflected by the emissive surface out of the LED lens, and a peak point may be formed between the second total-reflection surface and the third total-reflection surface.

The peak point may be formed at a point within a range of ⅗ to ¾ of a radius of the LED lens from a central axis of the LED chip.

The peak point may be formed at a point of ⅔ of the radius of the LED lens from the central axis of the LED chip.

The lower surface may include a first lower surface for connection between the incident surface and the first total-reflection surface and a second surface for connection between the third first total-reflection surface and the emissive surface, and the first lower surface and the second surface may be surface-processed so as to scatter incident light.

A connection surface widened away from an optical axis of the LED lens may be formed at a connection portion between the incident surface and the first lower surface and surface-processed so as to scatter incident light.

In another aspect of the present invention, provided herein is a light emitting diode (LED) lens for a backlight unit, for uniformly diffusing light emitted from an LED chip, the LED lens including a lower surface including an incident surface through which light emitted from the LED chip is incident upon the LED lens, an emissive surface from which the light incident upon the LED lens is emitted, and a total-reflection surface included in the lower surface so as to total-reflect the light emitted from the LED chip and incident upon the LED lens toward the emissive surface, wherein the lower surface includes a first lower surface for connection between the incident surface and the total-reflection surface and a second lower surface for connection between the total-reflection surface and the emissive surface, and the first lower surface and the second surface are surface-processed so as to scatter incident light.

A connection surface widened away from an optical axis of the LED lens may be formed at a connection portion between the incident surface and the first lower surface and may be surface-processed so as to scatter incident light.

The LED lens may further include a leg disposed on the second lower surface.

The total-reflection surface may include a first total-reflection surface convex downward and a second total-reflection surface connected to the first total-reflection surface and convex upward, and an inflection point may be formed between the first total-reflection surface and the second total-reflection surface.

The total-reflection surface may further include a third total-reflection surface that is connected to the second total-reflection surface and total-reflects light Fresnel-reflected by the emissive surface out of the LED lens, and a peak point may be formed between the second total-reflection surface and the third total-reflection surface.

### Advantageous Effects

A light emitting diode (LED) lens for a backlight unit with the above configuration according to an embodiment of the present invention may uniformly diffuse light even if an LED chip that emits light via a volume source is used as a light source.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a vertical cross-sectional view of a light emitting diode (LED) according to an exemplary embodiment of the present invention;

FIG. 2 is an enlarged view of a portion ‘A’ of FIG. 1;

FIG. 3 is a schematic diagram illustrating a state in which brightness deviation occurs around an optical axis of an LED lens due to Fresnel reflection at an emissive surface;

FIG. 4 is a vertical cross-sectional view of an LED lens according to another exemplary embodiment of the present invention and FIG. 5 is a bottom view of the LED lens illustrated in FIG. 4.

FIGS. 6 and 7 are diagrams illustrating optical distribution on a reflecting sheet of a backlight unit included in the LED lens illustrated in FIG. 4, FIG. 6 is a diagram illustrating optical distribution when a surface-processed connection surface is not formed, and FIG. 7 is a diagram illustrating optical distribution when a surface-processed connection surface is formed;

FIG. 8 is a diagram illustrating optical distribution when a first lower surface is surface-processed; and

FIG. 9 is a diagram illustrating improvement in optical distribution when a second lower surface is surface-processed, FIG. 9(a) is a diagram illustrating optical distribution when the second lower surface is not surface-processed, and FIG. 9(b) is a diagram illustrating optical distribution when the second lower surface is surface-processed.

### BEST MODE

Exemplary embodiments of the present invention are described in detail so as for those of ordinary skill in the art to easily implement with reference to the accompanying drawings.

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

In the drawings, the thicknesses of layers and regions are exaggerated for clarity. Accordingly, the present invention is not limited by the relative size and thickness illustrated in the accompanying drawings.

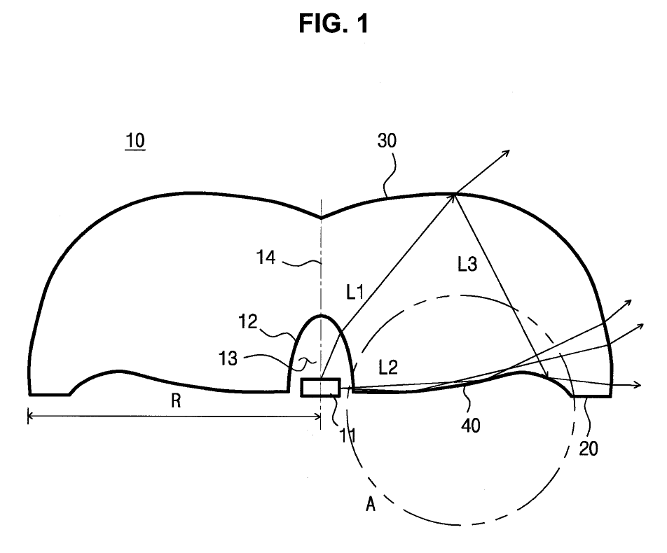

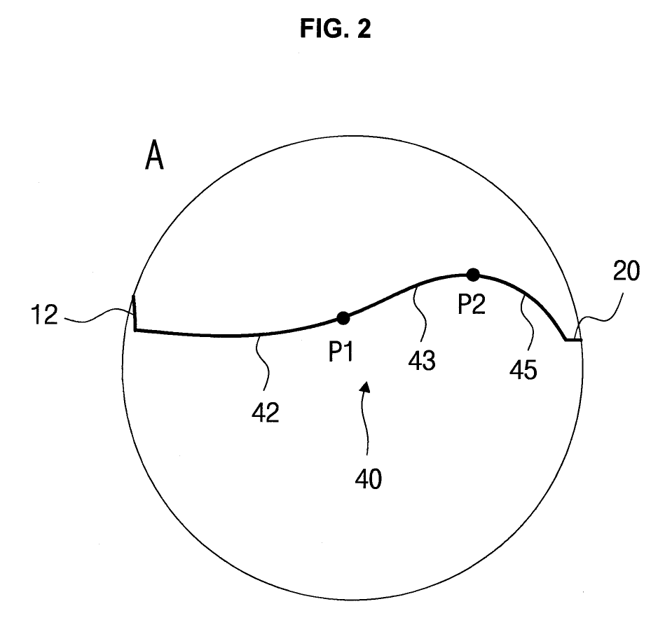

FIG. 1 is a vertical cross-sectional view of a light emitting diode (LED) according to an exemplary embodiment of the present invention. FIG. 2 is an enlarged view of a portion ‘A’ of FIG. 1.

Referring to FIGS. 1 and 2, an LED lens 10 according to embodiments of the present invention may include a lower surface 20 including an incident surface 12 through which light emitted from an LED chip 11 is incident upon the LED lens 10, and an emissive surface 30 from which light emitted from the LED chip 11 and incident upon the LED lens 10 is emitted.

The LED chip 11 may emit light via a volume source and the incident surface 12 may be disposed above the LED chip 11.

The incident surface 12 may be formed at a central portion of the lower surface 20 and may constitute an internal surface of an accommodation groove 13 for accommodation of the LED chip 11.

The LED lens 10 according to embodiments of the present invention may be configured in such a way that the emissive surface 30 is formed to be convex upward in order to more uniformly diffuse light emitted from the LED chip 11.

In particular, the emissive surface 30 of the LED lens 10 according to embodiments of the present invention may overall have a convex shape with one line without an inflection point.

Since the LED chip 11 emits light via a volume source, light L2 emitted from a lateral surface of the LED chip 11 as well as light L1 emitted from an upper surface of the LED chip 11 need to be considered in order to more uniformly diffuse light.

To this end, the LED lens 10 according to embodiments of the present invention may further include a total-reflection surface 40 that is included in the lower surface 20 and total-reflects the light L2 emitted from the lateral surface of the LED chip 11 and incident upon the LED lens 10 toward the emissive surface 30.

The total-reflection surface 40 may include a first total-reflection surface 42 connected to the incident surface 12 and convex downward and a second total-reflection surface 43 connected to the first total-reflection surface 42 and convex upward, and an inflection point P1 may be formed between the first total-reflection surface 42 and second total-reflection surface 43.

The inflection point P1 may be formed at a point within a range of ⅖ to ⅗ of a radius R of the LED lens 10 from a central axis 14 of the LED chip 11 and, more particularly, may be formed at a point of about ½ of the radius R of the LED lens 10 from the central axis 14.

The total-reflection surface 40 may further include a third total-reflection surface 45 that is connected to the second total-reflection surface 43 and total-reflects light L3 Fresnel-reflected by the emissive surface 30 toward the emissive surface 30. A peak point P2 may be formed between the second total-reflection surface 43 and the third total-reflection surface 45.

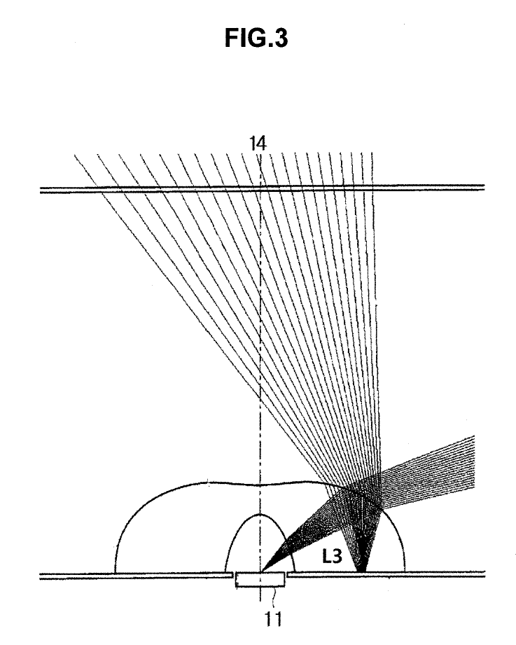

FIG. 3 is a schematic diagram illustrating a state in which brightness deviation occurs around an optical axis of an LED lens due to Fresnel reflection at an emissive surface.

As illustrated in FIG. 3, Fresnel reflection refers to reflection that occurs when light passes through a boundary surface between materials with different refractive indexes. In this regard, partial light L3 of the light L1 emitted through the emissive surface 30 is re-reflected toward the lower surface 20 according to Fresnel reflection and, thus, brightness deviation may occur around the optical axis 14 of the LED lens 10.

However, like the LED lens 10 according to embodiments of the present invention, when the total-reflection surface 40 further includes the third total-reflection surface 45, the light L3 that is Fresnel-reflected by the emissive surface 30 may be emitted from the LED lens 10, thereby reducing brightness deviation around the optical axis 14 of the LED lens 10 (refer to FIG. 1).

The peak point P2 may be formed at a point within a range of ⅗ to ¾ of the radius R of the LED lens 10 from the central axis 14 of the LED chip 11 and, more particularly, may be formed at a point of about ⅔ of the radius R of the LED lens 10.

When the LED lens 10 with the above configuration according to embodiments of the present invention is used, even if the LED chip 11 for emitting light via a volume source is used as a light source, light may be uniformly diffused.

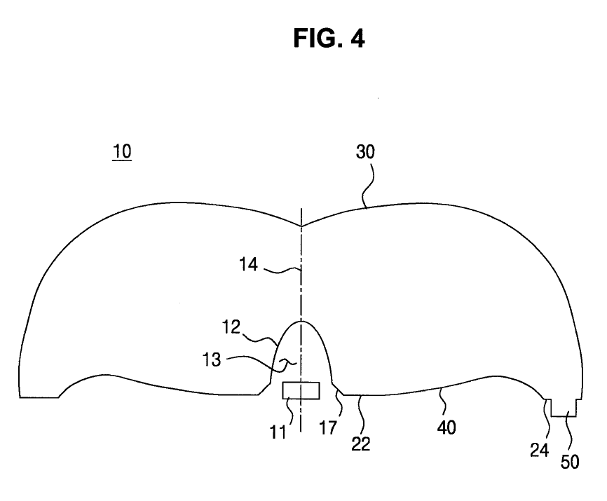

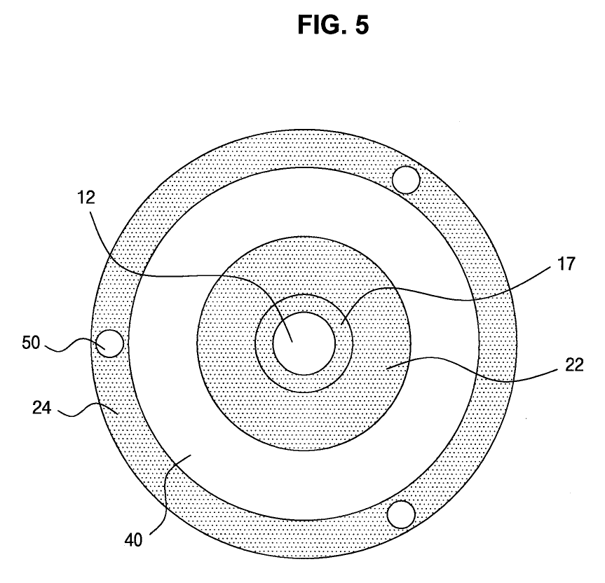

FIG. 4 is a vertical cross-sectional view of an LED lens according to another exemplary embodiment of the present invention. FIG. 5 is a bottom view of the LED lens illustrated in FIG. 4.

Referring to FIGS. 4 and 5, the lower surface 20 of the LED lens 10 according to embodiments of the present invention may include a first lower surface 22 for connection between the incident surface 12 and the total-reflection surface 40, and a second lower surface 24 for connection between the total-reflection surface 40 and the emissive surface 30.

The LED lens 10 according to embodiments of the present invention may further include a leg 50 protruding in a downward direction of the second lower surface 24.

As illustrated in FIG. 5, the LED lens 10 according to the present embodiment may be formed like an approximate circle in terms of a plane and at least three or more legs 50 may be spaced apart from each other by a predetermined interval in a circumferential direction thereof.

The LED lens 10 according to the present embodiment may further include a connection surface 17 formed at a connection portion between the incident surface 12 and the first lower surface 22.

The connection surface 17 may constitute a portion of the incident surface 12 and may be formed at an end portion of an edge of the incident surface 12, that is, at the connection portion between the incident surface 12 and the first lower surface 22.

As illustrated in FIG. 4, the connection surface 17 may be widened away from the optical axis 14 of the LED lens 10. Accordingly, a space of an end portion of an edge of the accommodation groove 13 may be widened.

As illustrated in FIG. 5, the connection surface 17 may be surface-processed so as to scatter light emitted from the LED chip 11. For example, surface processing may be performed by applying chemical corrosion or sanding corrosion to a core of a mold used in injection molding of the LED lens 10.

As such, when the connection surface 17 is surface-processed, light on a reflecting sheet of a backlight unit may be uniformly distributed and diffused without formation of a circular band shape.

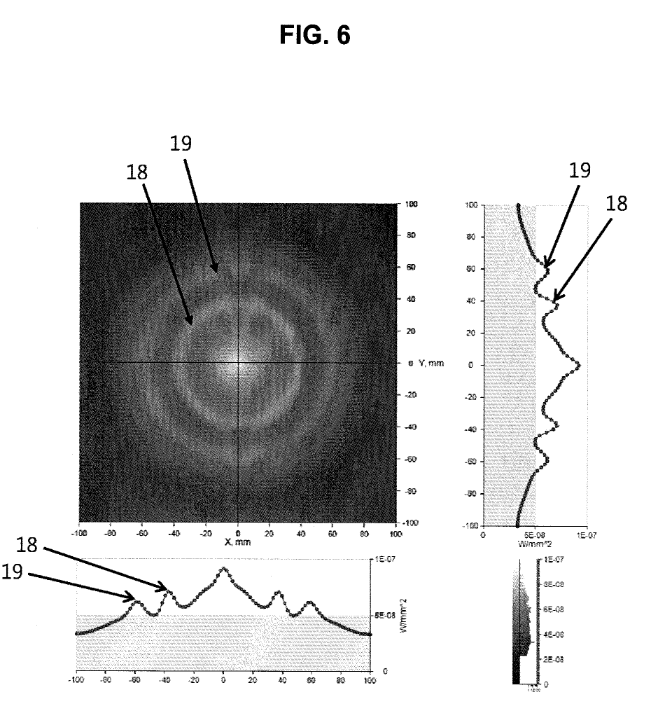

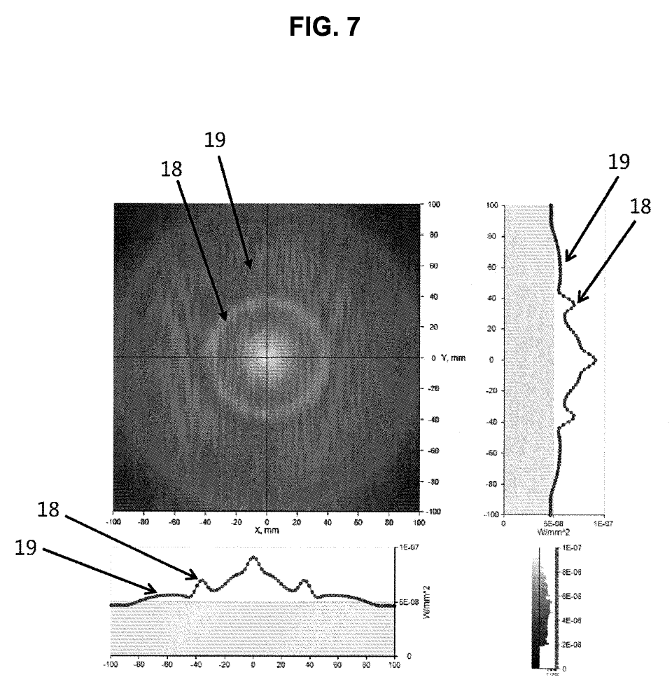

FIGS. 6 and 7 are diagrams illustrating optical distribution on a reflecting sheet of a backlight unit included in the LED lens illustrated in FIG. 4. FIG. 6 is a diagram illustrating optical distribution when a surface-processed connection surface is not formed and FIG. 7 is a diagram illustrating optical distribution when a surface-processed connection surface is formed.

As illustrated in FIG. 6, according to the optical distribution when the surface-processed connection surface 17 is not formed, two approximately circular bands 18 and 19 are formed, whereas, as seen from FIG. 7, according to the optical distribution when the surface-processed connection surface 17 is formed, the outer circular band 19 of the above two circular bands 18 and 19 is almost completely removed.

As illustrated in FIG. 5, in the LED lens 10 according to the present embodiment, the first lower surface 22 as well as the connection surface 17 may be surface-processed.

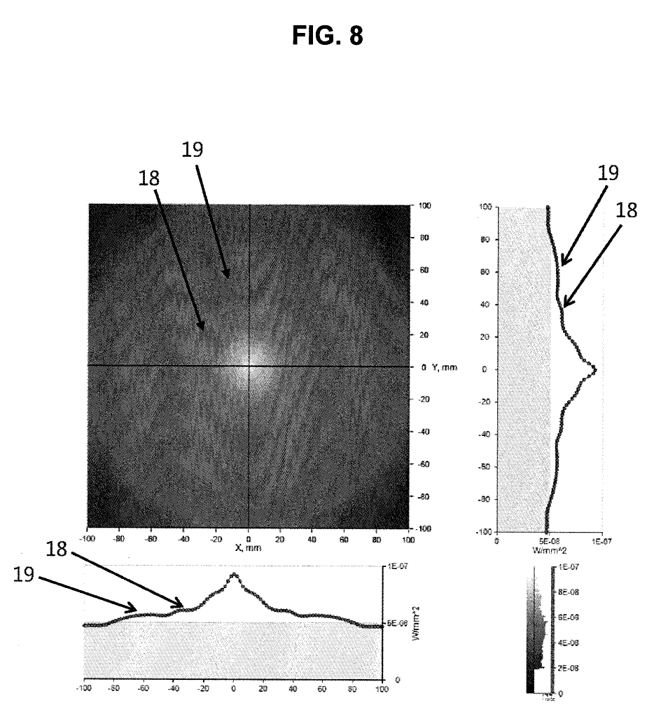

FIG. 8 is a diagram illustrating optical distribution when the first lower surface 22 is surface-processed.

As seen from FIG. 8, in the optical distribution when the first lower surface 22 is surface-processed, the inner circular band 18 of the above two circular bands 18 and 19 is also weakened.

As illustrated in FIG. 5, in the LED lens 10 according to the present embodiment, the second lower surface 24 including the leg 50 may be surface-processed.

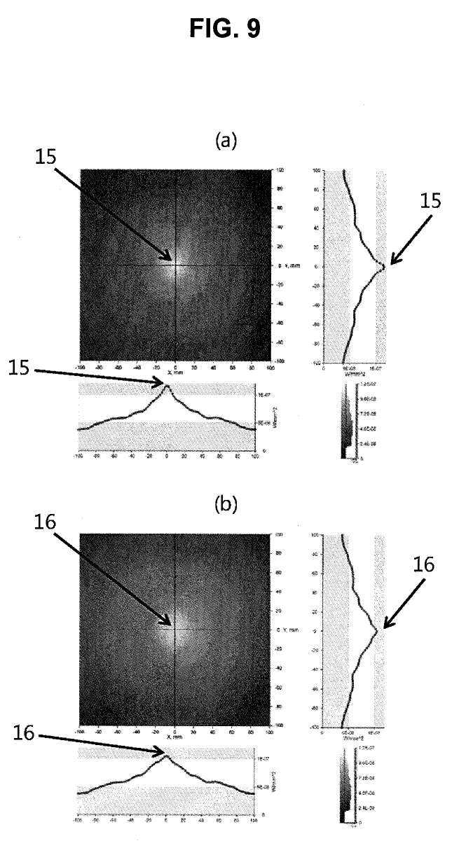

FIG. 9 is a diagram illustrating improvement in optical distribution when the second lower surface 24 is surface-processed. FIG. 9(a) is a diagram illustrating optical distribution when the second lower surface 24 is not surface-processed and FIG. 9(b) is a diagram illustrating optical distribution when the second lower surface 24 is surface-processed.

As seen from FIG. 9, when the second lower surface 24 including the leg 50 is surface-processed (FIG. 9(b)), a hot spot at a central portion of the LED lens 10, in which the LED chip 11 is disposed, is weakened compared with the case in which the second lower surface 24 is not surface-processed (FIG. 9(a)).

As described above, embodiments of the present invention relate to an LED lens for a backlight unit, for uniformly diffusing light even if an LED chip that emits light via a volume source is used and may be changed in various forms. Accordingly, while the present invention has been particularly shown and described with reference to exemplary embodiments thereof, it will be understood by those of ordinary skill in the art that various changes in form and details may be made therein without departing from the spirit and scope of the present invention as defined by the following claims. It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A light emitting diode (LED) lens for a backlight unit, for uniformly diffusing light emitted from an LED chip, the LED lens comprising:
a lower surface comprising an incident surface through which light emitted from the LED chip is incident upon the LED lens;
an emissive surface from which the light incident upon the LED lens is emitted; and
a total-reflection surface included in the lower surface so as to total-reflect the light emitted from the LED chip and incident upon the LED lens toward the emissive surface,
wherein:
the total-reflection surface comprises a first total-reflection surface convex downward and a second total-reflection surface connected to the first total-reflection surface and convex upward; and
an inflection point is formed between the first total-reflection surface and the second total-reflection surface.

2. The LED lens according to claim 1, wherein the inflection point is formed at a point within a range of ⅖ to ⅗ of a radius of the LED lens from a central axis of the LED chip.

3. The LED lens according to claim 2, wherein the inflection point is formed at a point of ½ of the radius of the LED lens from the central axis of the LED chip.

4. The LED lens according to claim 1, wherein:
the total-reflection surface further comprises a third total-reflection surface that is connected to the second total-reflection surface and total-reflects light Fresnel-reflected by the emissive surface out of the LED lens; and
a peak point is formed between the second total-reflection surface and the third total-reflection surface.

5. The LED lens according to claim 4, wherein the peak point is formed at a point within a range of ⅗ to ¾ of a radius of the LED lens from a central axis of the LED chip.

6. The LED lens according to claim 5, wherein the peak point is formed at a point of ⅔ of the radius of the LED lens from the central axis of the LED chip.

7. The LED lens according to claim 4, wherein:
the lower surface comprises a first lower surface for connection between the incident surface and the first total-reflection surface and a second surface for connection between the third first total-reflection surface and the emissive surface; and
the first lower surface and the second surface are surface-processed so as to scatter incident light.

8. The LED lens according to claim 7, wherein a connection surface widened away from an optical axis of the LED lens is formed at a connection portion between the incident surface and the first lower surface and is surface-processed so as to scatter incident light.

9. A light emitting diode (LED) lens for a backlight unit, for uniformly diffusing light emitted from an LED chip, the LED lens comprising:
a lower surface comprising an incident surface through which light emitted from the LED chip is incident upon the LED lens;
an emissive surface from which the light incident upon the LED lens is emitted; and
a total-reflection surface included in the lower surface so as to total-reflect the light emitted from the LED chip and incident upon the LED lens toward the emissive surface,
wherein:
the lower surface comprises a first lower surface for connection between the incident surface and the total-reflection surface and a second lower surface for connection between the total-reflection surface and the emissive surface; and
the first lower surface and the second surface are surface-processed so as to scatter incident light.

10. The LED lens according to claim 9, wherein a connection surface widened away from an optical axis of the LED lens is formed at a connection portion between the incident surface and the first lower surface and is surface-processed so as to scatter incident light.

11. The LED lens according to claim 9, further comprising a leg disposed on the second lower surface.

12. The LED lens according to claim 9, wherein:
the total-reflection surface comprises a first total-reflection surface convex downward and a second total-reflection surface connected to the first total-reflection surface and convex upward; and
an inflection point is formed between the first total-reflection surface and the second total-reflection surface.

13. The LED lens according to claim 12, wherein:
the total-reflection surface further comprises a third total-reflection surface that is connected to the second total-reflection surface and total-reflects light Fresnel-reflected by the emissive surface out of the LED lens; and
a peak point is formed between the second total-reflection surface and the third total-reflection surface.
